(19) United States
(12) Patent Application Publication
(10) Pub. No.: US 2007/0165810 A1
(43) Pub. Date: Jul. 19, 2007

(54) Invite Conference-Unaware Participant with Active Dialog to an Ad-Hoc Conference at the Application Server

(76) Inventors: Tuyet-Hoa Thi Nguyen, Allen, TX (US); Xiao-Gang Zhou, Plano, TX (US); Hai Xiong, Plano, TX (US)

Correspondence Address: CONLEY ROSE, P.C., 5700 GRANITE PARKWAY, SUITE 330, PLANO, TX, 75024, US

(21) Appl. No.: 11/562,288

(22) Filed: Nov. 21, 2006

Related U.S. Application Data
(60) Provisional application No. 60/757,677, filed on Jan. 10, 2006.

(51) Int. Cl. H04M 1/00

(52) U.S. Cl. 379/158

(57) ABSTRACT

A system and method for initiating a conference call is provided. The method consists of a first participant initiating a first telephony session with a second participant. The first participant then places the second participant on hold, initiates a second telephony session with a third participant, and initiates the conference call. A SIP REFER message related to the second and third participants is sent to an application server. A SIP INVITE message is sent to the second and third participants. The first telephony session is replaced with a session between the second participant and a conference bridge. The second telephony session is replaced with a session between the third participant and the conference bridge.

### CROSS-REFERENCE TO RELATED APPLICATIONS

This application claims priority to the provisional application, U.S. Pat. App. No, 60/757,677 entitled “Invite Conference-Unaware Participant with Active Dialog to an Ad-hoc Conference at the Application Server”, filed on Jan. 10, 2006, by Tuyet-Hoa Thi Nguyen, et al. The above-referenced provisional application is incorporated herein by reference.

### STATEMENT REGARDING FEDERALLY SPONSORED RESEARCH OR DEVELOPMENT

Not applicable.

### REFERENCE TO A MICROFICHE APPENDIX

Not applicable.

### BACKGROUND

Voice conferencing allows three or more individuals to communicate with one another simultaneously via a telecommunications link. Handheld electronic devices such as mobile telephones, personal digital assistants, handheld computers, and similar devices might be used to carry on a voice conference. A non-portable telephone might also be used. Any such device will be referred to herein as a handset.

### SUMMARY

In one embodiment, a method for initiating a conference call is provided. The method consists of a first participant initiating a first telephony session with a second participant. The first participant then places the second participant on hold, initiates a second telephony session with a third participant, and initiates the conference call. A SIP REFER message related to the second and third participants is sent to an application server. A SIP INVITE message is sent to the second and third participants. The first telephony session is replaced with a session between the second participant and a conference bridge. The second telephony session is replaced with a session between the third participant and the conference bridge.

In another embodiment, a communication system is provided. The communication system consists of a first handset operable to initiate a SIP session. The first handset is further operable to send a SIP REFER message, such that a second handset participates in a first SIP session with the first handset, and such that a third handset participates in a second SIP session with the first handset, and further such that an application server receives the SIP REFER message and, upon receipt of the SIP REFER message, sends a SIP INVITE message to the second handset and the third handset.

In another embodiment, a system for conducting a conference call is provided. The system consists of an application server operable to receive a SIP REFER message from a first handset. The application server is further operable, upon receipt of the SIP REFER message, to send a SIP INVITE message to a second handset and a third handset. The first handset is operable to initiate a SIP session and is further operable to send the SIP REFER message. The second handset is operable to participate in a first SIP session with the first handset. The third handset is operable to participate in a second SIP session with the first handset.

These and other features and advantages will be more clearly understood from the following detailed description taken in conjunction with the accompanying drawings and claims.

### BRIEF DESCRIPTION OF THE DRAWINGS

For a more complete understanding of the disclosure and the advantages thereof, reference is now made to the following brief description, taken in connection with the accompanying drawings and detailed description, wherein like reference numerals represent like parts.

FIG. 1 is a call flow diagram for establishing a conference call according to an embodiment of the disclosure.

FIG. 2 is a diagram of a wireless communications system including a handset operable for some of the various embodiments of the disclosure.

FIG. 3 is a block diagram of a handset operable for some of the various embodiments of the disclosure.

FIG. 4 is a diagram of a software environment that may be implemented on a handset operable for some of the various embodiments of the disclosure.

FIG. 5 illustrates an exemplary general-purpose computer system suitable for implementing the several embodiments of the disclosure.

### DETAILED DESCRIPTION

It should be understood at the outset that although an illustrative implementation of one embodiment of the disclosure is illustrated below, the system may be implemented using any number of techniques, whether currently known or in existence. The disclosure should in no way be limited to the illustrative implementations, drawings, and techniques illustrated below, including the exemplary design and implementation illustrated and described herein, but may be modified within the scope of the appended claims along with their full scope of equivalents.

Voice over Internet Protocol (VoIP) is a well-known system for telephone communication over the Internet. VoIP calls might be initiated and managed by the Session Initiation Protocol (SIP), an Internet Engineering Task Force (IETF) IP telephony signaling protocol, or by some other protocol. Embodiments of the disclosure use standard SIP messages to initiate conference calls.

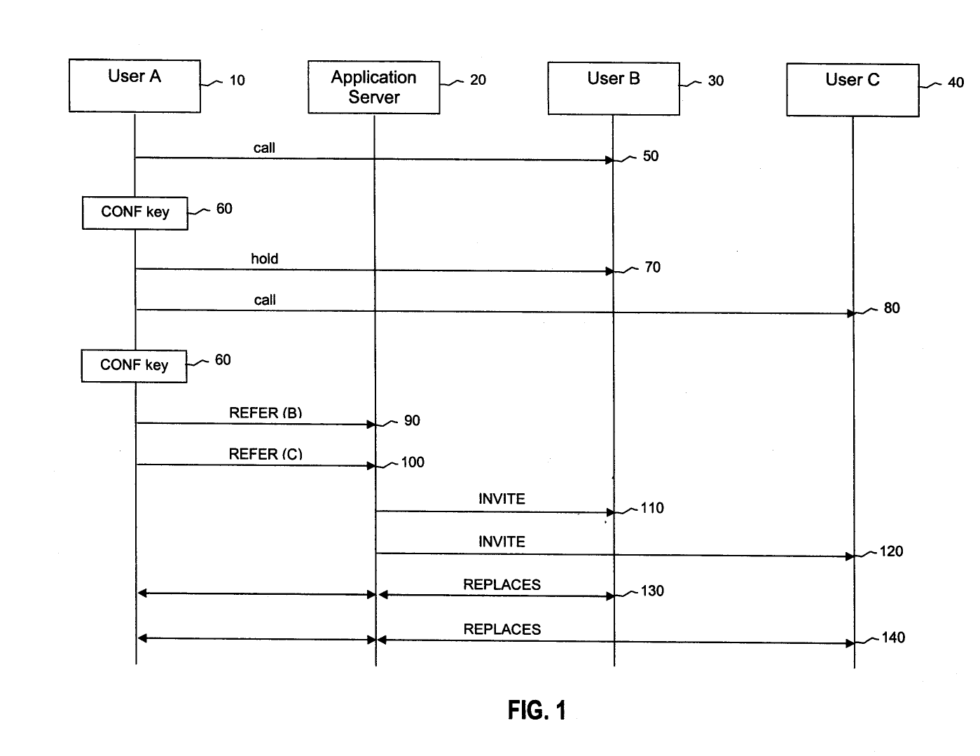

FIG. 1 is an embodiment of a call flow diagram for initiating a conference call. In this embodiment, the participants in the conference call are User A 10, User B 30, and User C 40. An application server 20 mediates the communications between the users. In event 50, User A 10 calls User B 30 and a call is set up between User A 10 and User B 30 using standard SIP INVITE and acknowledgement messages. The application server 20, in some embodiments is an IMS (IP (Internet Protocol) Multimedia Subsystem) server.

User A 10 then presses a conference key 60 or a similar input mechanism on the handset being used by User A 10. Pressing the conference key 60 places User B 30 on hold, as shown in event 70. While User B 30 is on hold, User A 10 calls User C 40, as shown in event 80. A call is then set up between User A 10 and User C 40 using standard SIP INVITE and acknowledgement messages.

User A 10 then again presses the conference key 60. The second press of the conference key 60 causes a first SIP REFER message, referring to User B, to be sent to the application server 20 in event 90. The first REFER message informs the application server 20 that User A 10 wishes to include User B 30 in a conference call. The second press of the conference key 60 also causes a second REFER message, referring to User C, to be sent to the application server 20 in event 100. The second REFER message informs the application server 20 that User A 10 wishes to include User C 40 in the conference call.

Upon receiving the REFER messages, the application server 20 sends an INVITE message to User B 30 in event 110. The application server 20 also sends an INVITE message to User C 40 in event 120. The INVITE messages sent by the application server 20 include a ‘Replaces’ header. As is well known in the art, a ‘Replaces’ header allows an existing SIP session to be replaced by another SIP session. In this case, the session between User A 10 and User B 30 is replaced with a conference between User A 10 and User B 30, and the session between User A 10 and User C 40 is replaced with a conference between User A 10 and User C 40. In this way, a conference call is set up among User A 10, User B 30, and User C 40.

Below is an example of SIP-compliant code that might be used for the INVITE message sent by the application server 20 to User C 40. It should be understood that this code is merely an example and that other coding syntax, other variable names, other programming languages, and other messaging protocols could be used to achieve similar functionality. Similar code might be used for the INVITE message sent to User B 30.

INVITE sip:User_C@c.com SIP/2.0
Replaces: aaa@a.com;to-tag=abcd;from-tag=1234>
From: AS.com; tag=as123
to: User_C@c.com
Call-ID: as122@AS.com

In event 130, the application server 20 is shown replacing the session between User A 10 and User B 30 with a conference session. In event 140, the application server 20 is shown replacing the session between User A 10 and User C 40 with a conference session. Although these are shown as separate events, one of skill in the art will recognize that the replacement of the sessions actually occurs upon acceptance by User B 30 and User C 40 of the INVITE messages containing the ‘Replaces’ headers.

One of skill in the art will also recognize that the above events do not necessarily need to occur in the order indicated. For example, the second pressing of the conference key 60 might cause the REFER message that applies to User B 30 to be sent to the application server 20 and the application server 20 might then send an INVITE message to User B 30. Subsequently, the REFER message that applies to User C 40 might be sent to the application server 20 and the application server 20 might then send an INVITE message to User C 40. That is, instead of a sequence of REFER, REFER, INVITE, INVITE, a sequence of REFER, INVITE, REFER, INVITE could be used.

In an alternative embodiment, the REFER message that is sent to the application server 20 in event 100 might instead be sent to User C 40. User C 40 might then choose to join the conference call by sending an INVITE message with a ‘Replaces’ header to the application server 20. This INVITE message from User C 40 to the application server 20 would be sent instead of the INVITE message sent from the application server 20 to User C 40, shown as event 120 in FIG. 1.

Embodiments of the present disclosure can be contrasted with previous conference call setup methods wherein a conference bridge is set up and then participants call in to the conference bridge. In the present embodiments, active calls are transferred into a conference bridge. The transfers into the conference bridge are carried out by SIP REFER and INVITE messages, which are traditionally used to transfer calls from one caller to another rather than from a caller to a conference bridge.

The use of the application server 20 to mediate conference calls allows multiple participants to be easily added to a conference call. The method described above for adding User C 40 to the conference call could be followed for additional participants and the number of participants that can be added in this manner might be limited only by the capabilities of the application server 20.

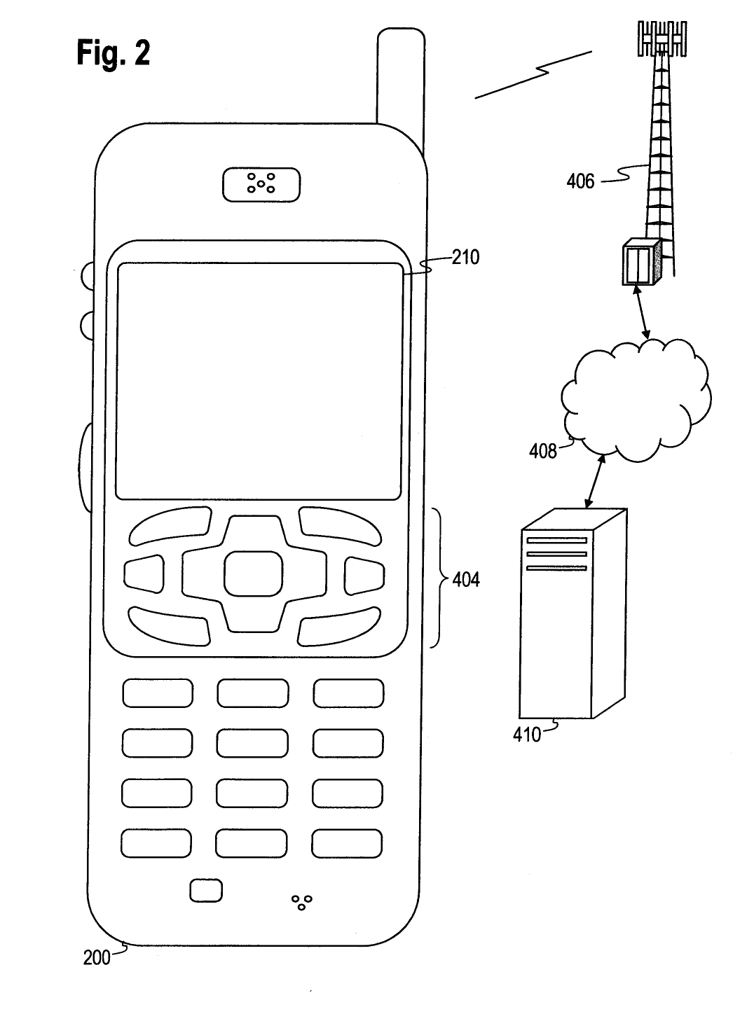

FIG. 2 shows a wireless communications system including a handset 200. The handset 200 is operable for implementing aspects of the present disclosure, but the present disclosure should not be limited to these implementations. Though illustrated as a mobile phone, the handset 200 may take various forms including a wireless handset, a pager, a personal digital assistant (PDA), a portable computer, a tablet computer, or a laptop computer. Many suitable handsets combine some or all of these functions. In some embodiments of the present disclosure, the handset 200 is not a general purpose computing device like a portable, laptop or tablet computer, but rather is a special-purpose communications device such as a mobile phone, wireless handset, pager, or PDA.

The handset 200 includes a display 210 and a touch-sensitive surface or keys 404 for input by a user. The handset 200 may present options for the user to select, controls for the user to actuate, and/or cursors or other indicators for the user to direct. The handset 200 may further accept data entry from the user, including numbers to dial or various parameter values for configuring the operation of the handset 200. The handset 200 may further execute one or more software or firmware applications in response to user commands. These applications may configure the handset 200 to perform various customized functions in response to user interaction.

Among the various applications executable by the handset 200 are a web browser, which enables the display 210 to show a web page. The web page is obtained via wireless communications with a cell tower 406, a wireless network access node, or any other wireless communication network or system. The cell tower 406 (or wireless network access node) is coupled to a wired network 408, such as the Internet. Via the wireless link and the wired network, the handset 200 has access to information on various servers, such as a server 410. The server 410 may provide content that may be shown on the display 110.

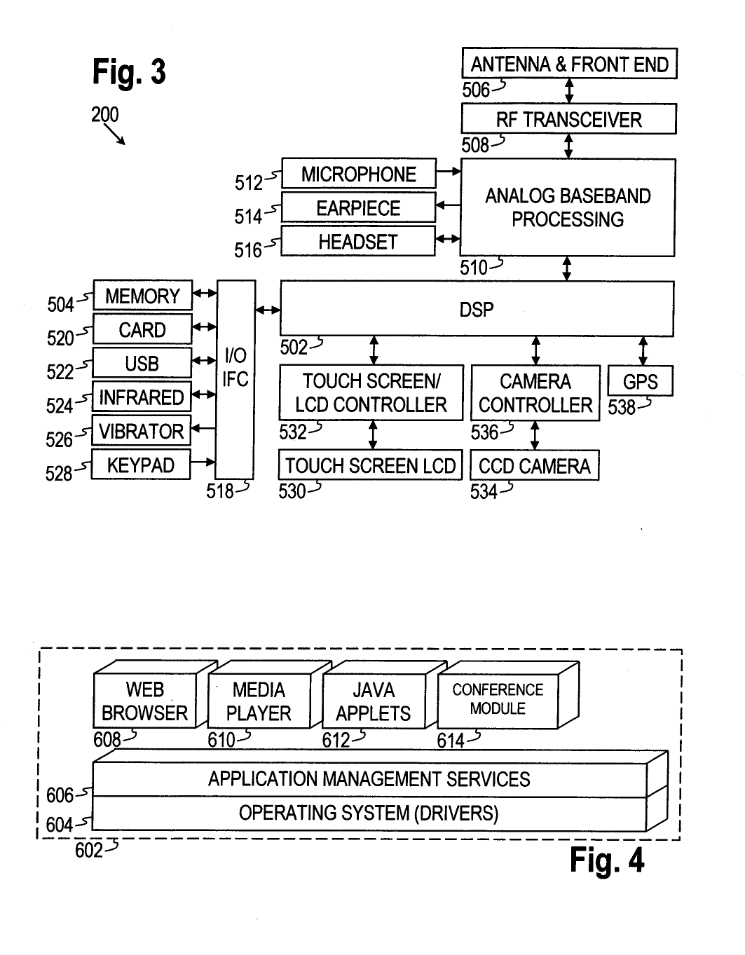

FIG. 3 shows a block diagram of the handset 200. The handset 200 includes a digital signal processor (DSP) 502 and a memory 504. As shown, the handset 200 may further include an antenna and front end unit 506, a radio frequency (RF) transceiver 508, an analog baseband processing unit 510, a microphone 512, an earpiece speaker 514, a headset port 516, an input/output interface 518, a removable memory card 520, a universal serial bus (USB) port 522, an infrared port 524, a vibrator 526, a keypad 528, a touch screen liquid crystal display (LCD) with a touch sensitive surface 530, a touch screen/LCD controller 532, a charge-coupled device (CCD) camera 534, a camera controller 536, and a global positioning system (GPS) sensor 538.

The DSP 502 or some other form of controller or central processing unit operates to control the various components of the handset 200 in accordance with embedded software or firmware stored in memory 504. In addition to the embedded software or firmware, the DSP 502 may execute other applications stored in the memory 504 or made available via information carrier media such as portable data storage media like the removable memory card 520 or via wired or wireless network communications. The application software may comprise a compiled set of machine-readable instructions that configure the DSP 502 to provide the desired functionality, or the application software may be high-level software instructions to be processed by an interpreter or compiler to indirectly configure the DSP 502.

The antenna and front end unit 506 may be provided to convert between wireless signals and electrical signals, enabling the handset 200 to send and receive information from a cellular network or some other available wireless communications network. The RF transceiver 508 provides frequency shifting, converting received RF signals to baseband and converting baseband transmit signals to RF. The analog baseband processing unit 510 may provide channel equalization and signal demodulation to extract information from received signals, may modulate information to create transmit signals, and may provide analog filtering for audio signals. To that end, the analog baseband processing unit 510 may have ports for connecting to the built-in microphone 512 and the earpiece speaker 514 that enable the handset 200 to be used as a cell phone. The analog baseband processing unit 510 may further include a port for connecting to a headset or other hands-free microphone and speaker configuration.

The DSP 502 may send and receive digital communications with a wireless network via the analog baseband processing unit 510. In some embodiments, these digital communications may provide Internet connectivity, enabling a user to gain access to content on the Internet and to send and receive e-mail or text messages. The input/output interface 518 interconnects the DSP 502 and various memories and interfaces. The memory 504 and the removable memory card 520 may provide software and data to configure the operation of the DSP 502. Among the interfaces may be the USB interface 522 and the infrared port 524. The USB interface 522 may enable the handset 200 to function as a peripheral device to exchange information with a personal computer or other computer system. The infrared port 524 and other optional ports such as a Bluetooth interface or an IEEE 802.11 compliant wireless interface may enable the handset 200 to communicate wirelessly with other nearby handsets and/or wireless base stations.

The input/output interface 518 may further connect the DSP 502 to the vibrator 526 that, when triggered, causes the handset 200 to vibrate. The vibrator 526 may serve as a mechanism for silently alerting the user to any of various events such as an incoming call, a new text message, and an appointment reminder.

The keypad 528 couples to the DSP 502 via the interface 518 to provide one mechanism for the user to make selections, enter information, and otherwise provide input to the handset 200. Another input mechanism may be the touch screen LCD 530, which may also display text and/or graphics to the user. The touch screen LCD controller 532 couples the DSP 502 to the touch screen LCD 530.

The CCD camera 534 enables the handset 200 to take digital pictures. The DSP 502 communicates with the CCD camera 534 via the camera controller 536. The GPS sensor 538 is coupled to the DSP 502 to decode global positioning system signals, thereby enabling the handset 200 to determine its position. Various other peripherals may also be included to provide additional functions, e.g., radio and television reception.

FIG. 4 illustrates a software environment 602 that may be implemented by the DSP 502. The DSP 502 executes operating system drivers 604 that provide a platform from which the rest of the software operates. The operating system drivers 604 provide drivers for the handset hardware with standardized interfaces that are accessible to application software. The operating system drivers 604 include application management services (“AMS”) 606 that transfer control between applications running on the handset 200. Also shown in FIG. 4 are a web browser application 608, a media player application 610, and Java applets 612. The web browser application 608 configures the handset 200 to operate as a web browser, allowing a user to enter information into forms and select links to retrieve and view web pages. The media player application 610 configures the handset 200 to retrieve and play audio or audiovisual media. The Java applets 612 configure the handset 200 to provide games, utilities, and other functionality. A conference module 614 can perform at least a portion of the conference calling functions described herein.

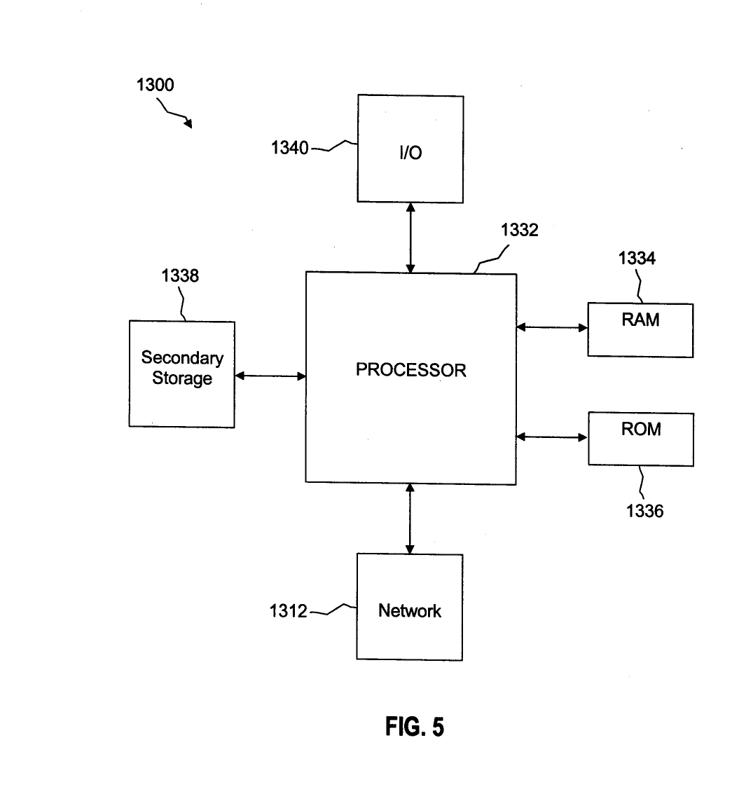

The handset 200 and the server 410 described above may be implemented on any general-purpose computer with sufficient processing power, memory resources, and network throughput capability to handle the necessary workload placed upon it. FIG. 5 illustrates a typical, general-purpose computer system 1300 suitable for implementing one or more embodiments disclosed herein. The computer system 1300 includes a processor 1332 (which may be referred to as a central processor unit or CPU) that is in communication with memory devices including secondary storage 1338, read only memory (ROM) 1336, random access memory (RAM) 1334, input/output (I/O) devices 1340, and network connectivity devices 1312. The processor 1332 may be implemented as one or more CPU chips.

The secondary storage 1338 is typically comprised of one or more disk drives or tape drives and is used for non-volatile storage of data and as an overflow data storage device if the RAM 1334 is not large enough to hold all working data. Secondary storage 1338 may be used to store programs which are loaded into the RAM 1334 when such programs are selected for execution. The ROM 1336 is used to store instructions and perhaps data which are read during program execution. The ROM 1336 is a non-volatile memory device which typically has a small memory capacity relative to the larger memory capacity of the secondary storage 1338. The RAM 1334 is used to store volatile data and perhaps to store instructions. Access to both ROM 1336 and RAM 1334 is typically faster than to secondary storage 1338.

I/O devices 1340 may include printers, video monitors, liquid crystal displays (LCDs), touch screen displays, keyboards, keypads, switches, dials, mice, track balls, voice recognizers, card readers, paper tape readers, or other well-known input devices.

The network connectivity devices 1312 may take the form of modems, modem banks, ethernet cards, universal serial bus (USB) interface cards, serial interfaces, token ring cards, fiber distributed data interface (FDDI) cards, wireless local area network (WLAN) cards, ultra-wideband (UWB) cards, radio transceiver cards such as code division multiple access (CDMA) and/or global system for mobile communications (GSM) radio transceiver cards, and other well-known network devices. These network connectivity devices 1312 may enable the processor 1332 to communicate with the Internet or one or more intranets. With such a network connection, it is contemplated that the processor 1332 might receive information from the network, or might output information to the network in the course of performing the above-described method steps. Such information, which is often represented as a sequence of instructions to be executed using the processor 1332, may be received from and outputted to the network, for example, in the form of a computer data signal embodied in a carrier wave.

Such information, which may include data or instructions to be executed using the processor 1332 for example, may be received from and outputted to the network, for example, in the form of a computer data baseband signal or signal embodied in a carrier wave. The baseband signal or signal embodied in the carrier wave generated by the network connectivity devices 1312 may propagate in or on the surface of electrical conductors, in coaxial cables, in waveguides, in optical media, for example optical fiber, or in the air or free space. The information contained in the baseband signal or signal embedded in the carrier wave may be ordered according to different sequences, as may be desirable for either processing or generating the information or transmitting or receiving the information. The baseband signal or signal embedded in the carrier wave, or other types of signals currently used or hereafter developed, referred to herein as the transmission medium, may be generated according to several methods well known to one skilled in the art.

The processor 1332 executes instructions, codes, computer programs, and scripts which it accesses from hard disk, floppy disk, optical disk (these various disk-based systems may all be considered secondary storage 1338), ROM 1336, RAM 1334, or the network connectivity devices 1312.

While several embodiments have been provided in the disclosure, it should be understood that the disclosed systems and methods may be embodied in many other specific forms without departing from the spirit or scope of the disclosure. The examples are to be considered as illustrative and not restrictive, and the intention is not to be limited to the details given herein. For example, the various elements or components may be combined or integrated in another system or certain features may be omitted, or not implemented.

Also, techniques, systems, subsystems and methods described and illustrated in the various embodiments as discrete or separate may be combined or integrated with other systems, modules, techniques, or methods without departing from the scope of the disclosure. Other items shown or discussed as directly coupled or communicating with each other may be coupled through some interface or device, such that the items may no longer be considered directly coupled to each other but may still be indirectly coupled and in communication, whether electrically, mechanically, or otherwise with one another. Other examples of changes, substitutions, and alterations are ascertainable by one skilled in the art and could be made without departing from the spirit and scope disclosed herein.

What is claimed is:

1. A method for initiating a conference call comprising:
a first participant initiating a first telephony session with a second participant;
the first participant placing the second participant on hold;
the first participant initiating a second telephony session with a third participant;
the first participant initiating the conference call;
sending a SIP (session initiation protocol) REFER message related to the second and third participants to an application server;
sending a SIP INVITE message to the second and third participants;
replacing the first telephony session with a session between the second participant and a conference bridge; and
replacing the second telephony session with a session between the third participant and the conference bridge.

2. The method of claim 1, wherein the placing the second participant on hold and the initiating the conference call are carried out by activating an input mechanism on a handset.

3. The method of claim 2, wherein activating the input mechanism causes the SIP REFER message to be sent.

4. The method of claim 1, further comprising the application server sending the SIP INVITE message upon receiving the SIP REFER message.

5. The method of claim 1, wherein the INVITE message contains a Replaces header that replaces a participant-to-participant session with a participant-to-conference bridge session.

6. The method of claim 1, where the first, second, and third participants communicate using a wireless handset is selected from a group of wireless handset consisting of: mobile telephones, personal communications services, cellular telephones, wireless communications devices, personal digital assistants, laptop computers, and tablet computers.

7. A communication system comprising:
a first handset operable to communication in a first SIP (session initiation protocol) session with a second handset, and operable to communicate in a second SIP session with a third handset, the first handset further operable to send a SIP REFER to an application server to prompt the application server to send a SIP INVITE message to the second handset and the third handset.

8. The communication system of claim 7, wherein the SIP INVITE message includes a Replaces header operable to replace the first SIP session with a conference between the second handset and a conference bridge and operable to replace the second SIP session with a conference between the third handset and the conference bridge.

9. The communication system of claim 7, wherein the first handset further comprises an input mechanism operable, when activated a first time, to place the first SIP session on hold and, when activated a second time, to send the SIP REFER message.

10. The communication system of claim 7, wherein the SIP REFER message instructs the application server to send the SIP INVITE message to the second handset and the third handset.

11. The communication system of claim 7, wherein the first handset is selected from a group of handsets consisting of: mobile telephones, wireless mobile devices, and personal digital assistants.

12. A system for conducting a conference call comprising:
an application server, such that when a first handset operably communicates in a first SIP (session initiation protocol) session with a second handset and the first handset operably communicates in a second SIP session with a third handset, the application server in response to receiving a SIP REFER message from the first handset sends a SIP INVITE message to the second handset and the third handset.

13. The system of claim 12, wherein the SIP INVITE message includes a Replaces header operable to replace the first SIP session with a conference between the second handset and a conference bridge and operable to replace the second SIP session with a conference between the third handset and the conference bridge.

14. The system of claim 12, wherein the first handset further comprises an input mechanism operable, when activated a first time, to place the first SIP session on hold and, when activated a second time, to send the SIP REFER message.

15. The system of claim 12, wherein the SIP REFER message instructs the application server to send the SIP INVITE message to the second handset and the third handset.

16. The system claim 12, wherein the first handset is selected from a group of handsets consisting of: mobile telephones, wireless mobile devices, and personal digital assistants.

17. The system of claim 16, wherein the second and third handsets are first handset is selected from a group of handsets consisting of: mobile telephones, wireless mobile devices, and personal digital assistants, laptop computers, and tablet computers.

18. The system of claim 12, wherein the application server is an IMS (IP (Internet Protocol) Multimedia Subsystem) server.

19. The system of claim 12, further comprising an IMS (IP (Internet Protocol) Multimedia Subsystem) system and wherein the application server is an IMS server in the IMS system.
